(19) United States
(12) Patent Application Publication
(10) Pub. No.: US 2018/0095168 A1
(43) Pub. Date: Apr. 5, 2018

(54) OPTOELECTRONIC SENSOR AND METHOD FOR OPTICAL MONITORING

(71) Applicant: SICK AG, Waldkirch (DE)

(72) Inventors: Christoph HOFMANN, Waldkirch (DE); Markus HAMMES, Waldkirch (DE); Joachim KRÄMER, Waldkirch (DE); Jörg SIGMUND, Waldkirch (DE)

(21) Appl. No.: 15/722,303

(22) Filed: Oct. 2, 2017

(30) Foreign Application Priority Data
Oct. 4, 2016 (DE) 10 2016 118 758.5

(51) Int. Cl. G01S 7/486; G01S 17/10; G01S 3/783

(52) U.S. Cl. CPC G01S 7/4865; G01S 3/783; G01S 17/10

(57) ABSTRACT

An optoelectronic sensor (10) for monitoring a monitoring region (12), the sensor (10) comprising an image sensor (16a-b), an illumination unit (20) for at least partially illuminating the monitoring region (12) with an illumination field (26), an illumination control (28) configured for a power adaption of the illumination unit (20) for meeting safety requirements, and an additional distance-measuring optoelectronic sensor (38) for detecting the distance at which an object (42) is located in the illumination field (26), wherein the illumination control (28) is configured for a power adaption in dependence on the distance measured by the additional sensor (38).

The invention relates to an optoelectronic sensor and a method for optically monitoring a monitoring area.

Numerous optoelectronic sensors use their own laser illumination. However, because of eye safety requirements, laser illuminations can either only be operated with severe limitations to optical output power, or they have to be classified into higher protection classes of laser standards, for example above class 1M in 3R, 3B or 4 according to EN 60825. The strict requirements for the operation of the device at higher protection classes are usually not acceptable. Similar requirements can also arise when other light sources are used, as for example for LEDs from EN 62471.

3D cameras acquire image data which also includes distance information which are referred to as three-dimensional images or depth maps. Depending on the 3D detection, an active illumination is essential for the sensor to operate, or at least leads to a better quality of the image data.

Time-of-flight cameras evaluate the time of flight of their transmission light in the pixels of their image sensors. One known method for these time-of-flight image sensors is photon mix detection.

Stereoscopic camera systems acquire several two-dimensional images of a scene from slightly different perspectives. In the overlapping image areas, corresponding structures are identified, and distances are calculated from the disparity and the optical parameters of the camera system by means of triangulation. In principle, stereoscopy is also possible as passive stereoscopy without its own illumination. However, if the scene to be monitored is poor in contrast or has regions with little structure, the stereoscopic evaluation is unreliable. At least two types of errors are conceivable, namely failing to find corresponding structure elements or a wrong correspondence. The results are gaps in the three-dimensional images or wrong calculations of the distances. This can be prevented by the artificial structure of a pattern illumination. In a modification of the stereoscopic principle, only one image is acquired and correlated with a known projection pattern, i.e. ultimately an evaluation of the distortion of the projection pattern by the contours in the scene.

In order to generate high-quality image data with 3D cameras even at larger ranges, the illumination should have a high power. This is particularly true for safety-related applications in which a source of danger is monitored and, if necessary, shut down by the 3D camera. On the other hand, it is desired to meet a laser protection class which is harmless in terms of eye safety, for example type 1 or 1M according to EN 60825. These contradictory requirements are not easy to match.

DE 10 2009 031 732 B3 describes a stereoscopic system which initially checks a provisional operating range with low optical output power. Only in case that no inadmissible objects are detected, it is switched to a higher laser power. A disadvantage is that there is a difference in an initial operation and a normal operation, rendering the process quite complicated. DE 10 2010 037 744 B3 refines this method by checking the near range during initial power-on in a different manner than by the stereo algorithm of the later normal operation. This of course cannot avoid the switchover as such.

DE 10 2009 013 735 A1 discloses a sensor for monitoring a monitoring region, wherein the sensor measures the power per unit area impinging on an object. Upon detection of an object, the power is adapted to prevent that a predetermined value is exceeded. This requires a continuous measurement of the incident radiation power, which is not only costly, but also unreliable due to a dependence on parameters like the object distance and remission properties of the object which are only partly known.

In US 2007/0001111 A, a laser projector is disclosed which for the protection of people detects persons within a protection zone directly in front of the projector by means of proximity sensors, in order to adjust the light power in dependence on a speed of the scanning movement of the projector and the feedback of the proximity sensors. This kind of eye safety approach is not suitable for a 3D camera.

GB 2 295 740 A discloses a laser-based range finder with a weak and a strong laser. The strong laser is only activated once no person has been detected while using the weak laser. This eye safety approach, which is related to a collimated laser, can again not be transferred to 3D cameras.

U.S. Pat. No. 6,661,820 B1 discloses a projector for structured light for use with an image sensor. Although the safe laser power is maximized, it is not adapted to the objects actually detected in the respective specific situation. Thus, only fixed assumptions are possible, and potential for increasing the light power in a scene with more favorable conditions than these assumptions remain unused.

In U.S. Pat. No. 8,290,208 B2 and similarly U.S. Pat. No. 9,201,501 B2, the power of a laser projector is adapted when there are persons in the projection field. However, a very complex image analyse is carried out for this purpose.

It is therefore an object of the invention to improve the power adaptation of an illumination of an optoelectronic sensor.

This object is satisfied by an optoelectronic sensor, in particular a 3D camera, for monitoring a monitoring region, the sensor comprising an image sensor, an illumination unit for at least partially illuminating the monitoring region with an illumination field, an illumination control configured for a power adaption of the illumination unit for meeting safety requirements, and an additional distance-measuring optoelectronic sensor for detecting the distance at which an object is located in the illumination field, wherein the illumination control is configured for a power adaption in dependence on the distance measured by the additional sensor.

The sensor has an illumination unit, preferably divergent for illuminating an extended scene of a 3D camera. Throughout this specification, preferably refers to a preferred, but completely optional feature. In order to properly illuminate the monitoring region and achieve a high range on the one hand and to meet safety requirements such as eye safety on the other, the power of the illumination is adapted in accordance with the actual situation. The invention starts from the basic idea to use an additional sensor in order to obtain information about possible objects in the illumination field which should be taken into consideration. The additional sensor is a separate second sensor in addition to the image sensor and the illumination unit of the main sensor, but they may commonly use general components like a supply, housing and possibly some optical elements. The illumination control adapts the power to the measured distance of an object located in the illumination field. This includes the case of an illumination field being free of objects, because in that case the additional sensor provides distance information that any objects are farther away than its measuring range.

The object is also satisfied by a method for optically monitoring a monitoring region which is at least partially illuminated with an illumination field by an illumination unit, wherein the power of the illumination unit is adapted in order to meet safety requirements, wherein the distance at which an object is located in the illumination field is detected by an additional distance-measuring optoelectronic sensor, and wherein the power is adapted in dependence on the distance measured by the additional sensor.

The invention has the advantage that there is an appropriate power adjustment to a situational hazard assessment for the protection against electromagnetic radiation. This avoids the conventional design on the basis of worst case assumptions, which unnecessarily limit the energy balance. Thus, the illumination unit can be operated with high illumination power, while for example the classification as a laser device of the type 1M according to DIN EN 60825-1 is retained. Additional safety measures, such as required for example with higher laser protection classes, need not be taken. No initial power-on phase with reduced power of the illumination unit is required, the sensor directly operates in a normal operation, provided that the independent distance-measuring additional sensor does not detect an object in a dangerous distance. Inexpensive and compact additional sensors are available which can easily be integrated into the sensor or even the illumination unit, or which can be retrofitted.

The illuminating field preferably comprises a region where a maximal power density impinges on an eye, wherein the additional sensor measures the distance relative to the region. In contrast to first appearance, this region is not in the nearest possible distance, because although there the eye is generally affected by a large amount of light, this is distributed over a larger retinal surface. Therefore, it is useful to determine the most dangerous distance range and to measure the distances used for the power adaption relative thereto. Moreover, the additional sensor preferably measures collinearly or parallel, respectively, to the propagation direction of the illumination so that objects at the relevant position in the relevant direction are detected.

The power preferably is adapted according to a permissible maximum value. For an optimal energy balance, not only is the maximum value not exceeded, but also at least almost reached, thus making use of the possible illumination performance. The maximum value preferably is derived from eye safety requirements, such as the EN 60825 standard.

The maximum value preferably is adapted to the measured distance. This can be achieved with a function of the maximum value in dependence on the measured distance, this function being continuous or discrete. In practice, a few steps of a discrete function can suffice, for example, one maximum value each for near distances, for distances in the range in which a maximum power density impinges on an eye, and for longer distances. For objects at certain distances, the appropriate response may also be an immediate power-off of the illumination unit, i.e. the maximum value for this distance range can be set to zero.

The illumination unit preferably is configured to operate the illumination unit in a pulsed manner and to control the power adaption by at least one of a pulse repetition frequency, a pulse length and a pulse amplitude. The decisive factor for damage to the eye is not the instantaneous, but the average integrated power. Therefore, the power adaption does not necessarily have to adapt the pulse amplitude or only the pulse amplitude, but can also use the duration and frequency of the pulses as the adapted parameter. The average optical output power can be controlled particularly easily via the pulse sequences, and the power can better be bundled, possibly in synchrony with reception time windows.

The additional sensor preferably comprises a SPAD (single-photon avalanche detector). SPADs are avalanche photodiodes operated in the so-called Geiger mode, which are biased with a high bias voltage above the breakdown voltage. As a result, even a single incident photon can already trigger the avalanche breakdown and thus a detection signal. A distance measuring device with a SPAD light receiver can be particularly cost-effective and compact, but still carry out sufficiently precise distance measurements.

The additional sensor preferably comprises its own illumination unit. Thus a distance can for example be measured with a light time of flight method. The own illumination unit preferably is eye-safe over its entire illumination range and is not adjusted in dependence on the actual situation. It is therefore usually weaker than the illumination unit of the 3D camera. A reduced range is not a problem, since the illumination field of the illumination unit of the 3D camera anyway is not dangerous anymore at farther distances, in particular in case it is divergent.

The own illumination unit of the additional sensor preferably has an expanded ring-shaped or line-shaped beam cross-section. In an alternative point-like measurement, the additional sensor monitors only a very small part of the illumination field. This might even be sufficient if the critical regions are locally concentrated in the illumination field and can be monitored with one or few point measurement. However, with a larger light spot and therefore detection area, a correspondingly larger part of the illumination field can be monitored, so that an incidence with a missed object occurs less frequently or not at all.

Preferably, a plurality of additional sensors is provided. This is an alternative or additional measure to improve coverage of the illumination field. The additional sensors can actually be a plurality of separate sensors, but also an arrangement of a multiple light source, such as a laser line or a VCSEL array, and a receiver matrix can be regarded as a plurality of additional sensors. Similarly, the evaluation for determining the distance can be separate or shared. The additional sensors can each be either point-like as an individual additional sensor, or measure with an extended beam cross-section.

The sensor when configured as a 3D camera can use any known technique for acquiring depth maps, for example be a light time of flight camera or a stereo camera as explained in the introduction.

In a preferred embodiment, a shut-down device is provided, which is configured to output a shutdown signal to a monitored source of danger or machine if an inadmissible object intrusion is detected. An inadmissible object intrusion can be detected by the 3D camera itself, for example whether there is an unknown object in a protected region, in particular too close to a monitored machine. However, it is also possible that an object detected by the additional sensor requires a power adaption which does no longer guarantee a reliable monitoring by the 3D camera, which also results in a safety-related shutdown.

The illumination unit preferably comprises a laser light source. Laser light sources have a very high output power, and their coherent properties can be used to form structured patterns with high efficiency. Thus, a high-power structured illumination pattern can be projected into the monitoring region with a pattern generating element. With other light sources, such as LEDs, an output power potentially damaging the eyes is also possible, and therefore the invention can be used to meet safety regulations, for example, according to the standard DIN 62471 relevant for LEDs.

The method according to the invention can be modified in a similar manner and shows similar advantages. Further advantageous features are described in the sub claims following the independent claims in an exemplary, but non-limiting manner.

The invention will be explained in the following also with respect to further advantages and features with reference to exemplary embodiments and the enclosed drawing. The Figures of the drawing show in:

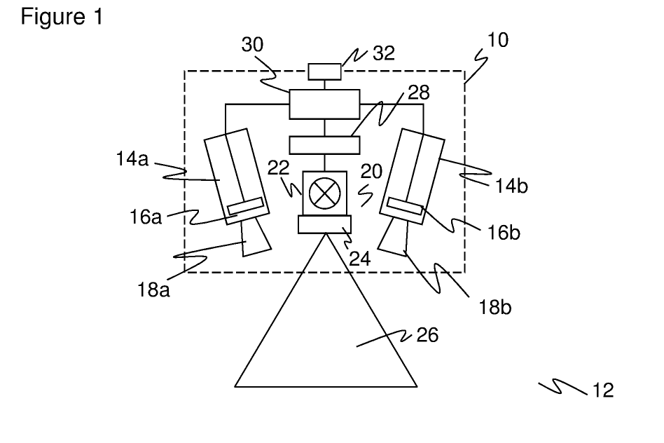

FIG. 1 a schematic view of a stereoscopic 3D camera;

FIG. 2 exemplary plots of a function, each in dependence on the distance: in the left part of the diameter of the light spot of a laser source on the retina, in the middle part of the intensity of the laser source, and in the right part of the power density resulting on the retina;

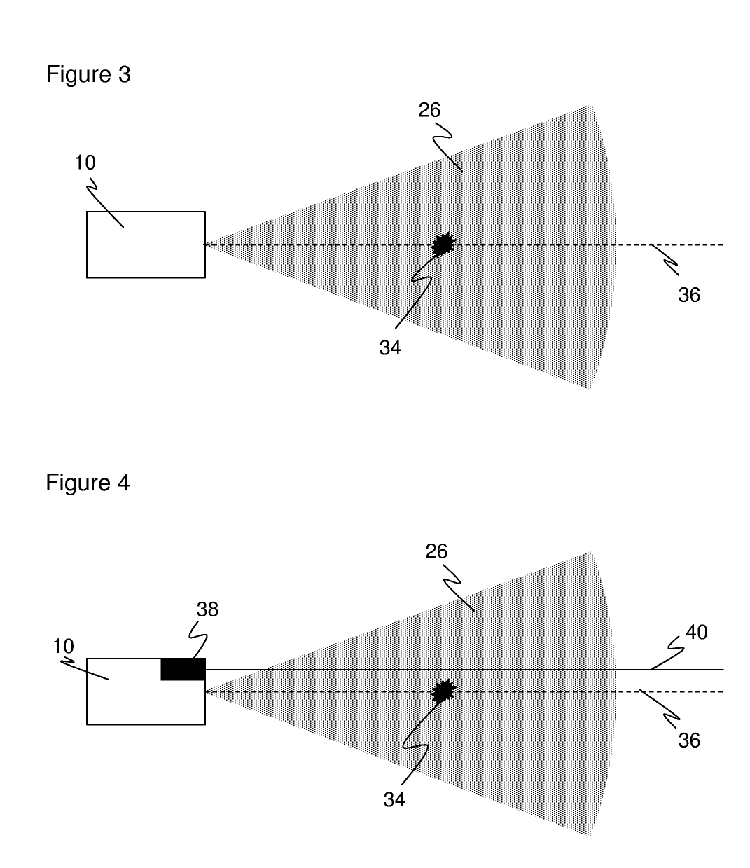

FIG. 3 a schematic view of the illumination field and the most dangerous point for an eye of a 3D camera;

FIG. 4 a schematic view of a 3D camera similar to FIG. 3, with an additional sensor;

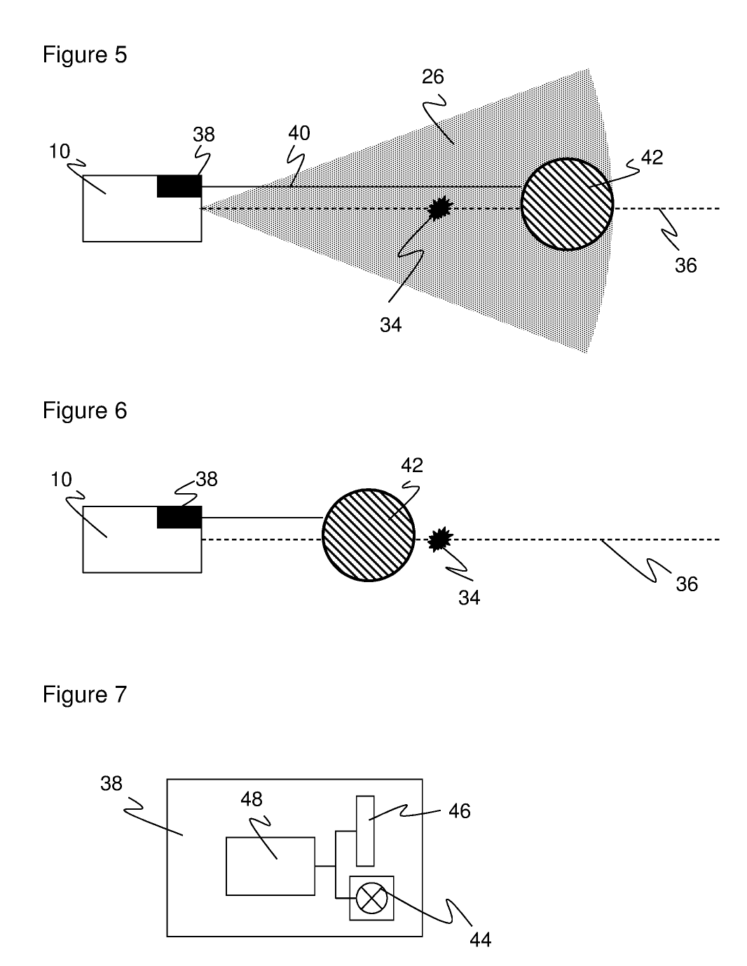

FIG. 5 a schematic view, where in the illumination field of the 3D camera according to FIG. 4 there is an object;

FIG. 6 a schematic view according to FIG. 5, wherein after detection of the object in a dangerous distance the illumination field is turned off; and

FIG. 7 a schematic block diagram of an additional sensor for measuring the distance of objects in the illumination field.

15

FIG. 1 shows a schematic view of the general structure of a 3D camera 10 according to the stereo principle for detecting a spatial area 12. The invention also includes other sensors, in particular other cameras and 3D cameras such as a light time of flight camera or a camera which correlates a projection pattern with an acquired image.

Two camera modules 14a, 14b are mounted at a known fixed distance to one another and acquire respective images of the spatial area 12. In each camera, an image sensor 16a, 16b is provided, usually a matrix-shaped acquisition chip which acquires a rectangular pixel image, for example a CCD sensor or a CMOS sensor which can also be configured as a SPAD-matrix. An objective 18, 18b with imaging optics is arranged in front of each of the image sensors 16a, 16b.

An illumination unit 20 is provided between the two image sensors 16a, 16b, wherein a central arrangement is merely an example. The illumination unit 20 comprises a light source 22, for example one or several lasers or LEDs, as well as a pattern generating element 24, which for example is configured as a mask, a phase plate, a micro lens array, or a diffractive optical element. Therefore, the illumination unit 20 is able to illuminate the spatial area 12 with an illumination field 26 which comprises a structured pattern. An illumination control 28 switches the light source 22 and determines its optical power.

A control 30 is connected to the two image sensors 16a, 16b and the illumination control 28. The control 30 receives image data of the image sensors 16a, 16b and calculates three dimensional image data (distance image, depth map) of the spatial area 12 by means of stereoscopic disparity estimation. The structured illumination patter ensures a high contrast and thus a structure of each image element in the illuminated spatial area 12 which can clearly be matched. Accordingly, the structured pattern and thus the pattern generating element 24 is not required in a sensor with a different kind of distance measurement, such as a light time of flight camera.

Depending on the application of the 3D camera, the three-dimensional image data is output at an output 32, or there is an internal further processing. In a safety application, for example, it is monitored whether there are objects in a dangerous area, and in that case a safety-related shutdown signal is output to a source of danger. To that end, out-put 32 may be configured as a safe output (OSSD, Output Signal Switching Device). A sensor used in the field of safety technology is configured to be failsafe. For contactless protective devices, the required measures are standardized in EN 61496-1 or IEC 61496 as well as in DIN EN ISO 13849 and EN 61508. A corresponding standard for safety cameras is in preparation.

When operating an optoelectronic sensor with active illumination, such as the 3D camera 10, adequate protection against electromagnetic radiation must be ensured. The protective requirements or safety requirements will be explained using the example of the laser eye protection according to EN 60825. The eye is typically the most sensitive target so that other possible protective requirements are automatically met. Nevertheless, other protection goals, such as skin protection or merely technical reasons like avoiding to much stray light, are also conceivable.

For the hazard assessment and compliance with a laser class such as 1 M, all accessible distances between the eye and the location of the apparent source of the light have to be considered and evaluated with regard to the damaging power density, i.e. the ratio of incident power and area of the retinal image. The most unfavorable distance is relevant for the classification of the laser device. Due to a small exit pupil of the projection objective of the illumination unit 20 at a large field angle, the eye pupil acts as a field aperture and limits the image of the source with increasing distance. At near distances, the retinal image becomes increasingly larger, so that the overall increasing light quantity within the iris acting as a measuring aperture is distributed over a larger retinal surface area. On the other hand, although for very far distances the image of the source on the retina is very small and thus the received radiation is very concentrated, in total only very little light impinges on the retina due to the large divergence of the illumination. Consequently, the danger is at a maximum for an intermediate distance to be determined. This most unfavorable or most dangerous distance is relevant for the classification of the laser device.

FIG. 2 illustrates how the most dangerous distance can be determined. The eye is modeled as an auxiliary lens which captures part of the radiation of the illumination field 26. In the left part, FIG. 2 shows the radius of the laser source which is imaged onto the retina by the auxiliary lens in dependence on the distance to the laser source. In order to take account for the variable accommodation capacity of the human eye, lens focal lengths between f′=+14.5 mm and f′=+17 mm are considered for each distance. The minimum focal length f′=+14.5 mm corresponds to an object distance of g=100 mm, the maximum value f′=+17 mm to an object distance of g=∞.

In the middle part of FIG. 2, the distance-dependent intensity profile for a measuring aperture of the diameter 7 mm corresponding to the iris is shown. In the right part of FIG. 2, the power density on the retina, which is decisive for damage to the eye, is plotted as a function of the distance. This results from dividing the power impinging on the retina according to the middle part of FIG. 2 by the area of the resultant retinal image corresponding to the radius shown in the left part of FIG. 2.

As can be inferred from the right part of FIG. 2, the power density on the retina of the eye in dependence on the distance to the source of danger forms a distinct maximum. For other distances than that maximum, the danger is reduced. All limit value considerations for class 1M are based on this most dangerous scenario for the human eye with maximum power density impinging on the retina.

FIG. 3 again illustrates the most dangerous region 34 in the illumination field 26. The 3D camera 10 explained with reference to FIG. 1 is only shown as a function block. Determination of the least favorable distance on the optical axis 36 has just been described. Laterally, i.e. upwards or downwards in FIG. 3, the radiation power can only decrease because of the edge drop of the projection optics.

With a situational danger assessment which takes the distance between a person actually present and the light source 22 into account, the permissible illumination power can be readjusted in order to achieve a stronger illumination which nevertheless satisfies the required eye protection class for each distance.

FIG. 4 shows a modification of the 3D camera 10 with an additional sensor 38 which is a distance-measuring optical sensor. An electronic control is provided, for example within the illumination control 28, which prevents that the light power limit values determined for the 3D camera 10 in dependence on application and safety class are exceeded. However, the light power limit values are not fixedly set based on worst-case assumptions, but are adapted to the actual situation. For this propose, it is detected by the additional sensor 38 whether there actually is an object in the beam path 40 of the additional sensor 38 within the most dangerous region 34, or the distance of an object detected in the illumination field 26 to the most dangerous region 34 is determined, respectively. Thus, it is possible to operate the illumination unit 20 with a higher power where the limit values for eye safety are no longer met within the most dangerous area 34. This does not affect the classification, since the accessibility is excluded based on the sensor function of the additional sensor 38.

FIG. 5 shows an exemplary first situation with an object 42 at a farther distance, in particular beyond the most dangerous region 34. The 3D camera 10 can remain in normal operation and also increase the power of the illumination unit 20 depending on the distance of the object 42.

FIG. 6 shows a further exemplary situation with a very near object 42 in front of the most dangerous area 34. The power of the illumination unit 20 has to be reduced accordingly. What is shown is a particularly drastic reduction: the illumination field 26 is turned off completely.

As illustrated by these two examples, the additional sensor 38 provides distance values which can be used to for power adaption. The distance values preferably are measured relative to the most dangerous region 34 and collinear or parallel, respectively, to the propagation direction of the electromagnetic radiation of the illumination field 26. It is preferably measured as close as possible to the optical axis 36 of the illumination unit 20. This makes sure that it is measured in the immediate vicinity of the danger, and for example the head of a person can be detected before the person's eye is exposed to the dangerous electromagnetic radiation.

Depending on the measured distance D to a detected object, new threshold values S(D) are then set for the limit values permissible according to the protection class or safety class. The dependency can be stored as a continuous or discrete function. The threshold values S(D) are communicated to the control circuit, so that the protection against electromagnetic radiation always matches the actual danger situation. When setting the thresholds, a latency of the relevant overall system of additional sensor 38, illumination control 28 and illumination unit 20 as well as the time until there is an injury should be taken into account.

FIG. 7 shows, in a very schematic block diagram, an exemplary design of the additional sensor 38. In this embodiment, the distance is measured with a light time of flight (TOF) method, but other methods are also possible. A light transmitter 44 referred to as an own light transmitter 44 of the additional sensor transmits a light signal which is detected by a light receiver 46, for example a sensitive and compact SPAD light receiver, after remission at an object. The light signal is modulated, either with short light pulses or a periodic signal, and the time interval between transmission and reception of a pulse or a phase offset is determined accordingly in a light time of flight unit 48, which is converted into a distance via the constant light velocity.

The light transmitter 44 is preferably eye-safe, which means eye-safe in itself for any distance without power adaption. This reduces the range which may be smaller than the range of the illumination field 26. The reduced range could only be relevant for an illumination unit with collimated radiation, which anyway would not be useful in a 3D camera 10. For divergent radiation which typically is generated by the illumination unit 20 because usually an area is to be illuminated, it is sufficient that the most dangerous region 34 is within the range of the additional sensor 38, possibly with some buffer. The light transmitter 44 is preferably separated from the illumination field 26, for example by time shift, by coding or by wavelength, in order not to interfere with the three-dimensional image data acquisition. It is also conceivable for the additional sensor 38 to be deactivated as soon as the 3D camera 10 is in normal operation, and to then replace its function by an evaluation of the image data. There are advantages in configuring the light transmitter 44 as a spot radiator, since that beam cross-section provides maximal distance measurement accuracy. On the other hand, a larger part of the illumination field 26 can be covered with an extended light spot such as a line-shaped or ring-shaped light spot. This effect can also be achieved by using a plurality of additional sensors 38.

It is possible to indicate via status LEDs whether the illumination unit 20 is operated in a mode with a certain average optical radiation power. The additional sensor 38 can be an integral part of the illumination unit 20 or of the 3D camera 10, or it can be retrofitted. The power adaptation according to the invention based on a distance-measuring additional sensor 38 is useful not only in a sensor, in particular a 3D camera 10, but also for example in a laser device of science, an industrial laser for cutting or welding, or in telecommunications. It can for example be used for an adjustment operation with low power and a normal operation with high power.

1. An optoelectronic sensor (10) for monitoring a monitoring region (12), the sensor (10) comprising an image sensor (16a-b), an illumination unit (20) for at least partially illuminating the monitoring region (12) with an illumination field (26), an illumination control (28) configured for a power adaption of the illumination unit (20) for meeting safety requirements, and an additional distance-measuring optoelectronic sensor (38) for detecting the distance at which an object (42) is located in the illumination field (26), wherein the illumination control (28) is configured for a power adaption in dependence on the distance measured by the additional sensor (38).

2. The sensor (10) according to claim 1,
wherein the sensor (10) is a 3D camera.

3. The sensor (10) according to claim 1,
wherein the illuminating field (26) comprises a region (34) where a maximal power density impinges on an eye, and wherein the additional sensor (38) measures the distance relative to the region (34).

4. The sensor (10) according to claim 1,
wherein the power is adapted according to a permissible maximum value.

5. The sensor (10) according to claim 4,
wherein the maximum value is adapted to the measured distance.

6. The sensor (10) according to claim 1,
wherein the illumination unit (28) is configured to operate the illumination unit (20) in a pulsed manner and to control the power adaption by at least one of a pulse repetition frequency, a pulse length and a pulse amplitude.

7. The sensor (10) according to claim 1,
wherein the additional sensor (38) comprises a single-photon avalanche detector (46).

8. The sensor (10) according to claim 1,
wherein the additional sensor (38) comprises its own illumination unit (44).

9. The sensor (10) according to claim 8,
wherein the own illumination unit (44) has an expanded ring-shaped or line-shaped beam cross-section.

10. The sensor (10) according to claim 1,
wherein a plurality of additional sensors (38) are provided.

11. A method for optically monitoring a monitoring region (12) which is at least partially illuminated with an illumination field (26) by an illumination unit (20), wherein the power of the illumination unit (20) is adapted in order to meet safety requirements, wherein the distance at which an object (42) is located in the illumination field (26) is detected by an additional distance-measuring optoelectronic sensor (38), and wherein the power is adapted in dependence on the distance measured by the additional sensor (38).
